(19) United States
(12) Patent Application Publication
(10) Pub. No.: US 2026/0087033 A1
(43) Pub. Date: Mar. 26, 2026

(54) ADAPTIVELY EXTRACTING CAPTURED OPERATIONAL SENSOR DATA TO BE RETAINED

(71) Applicant: TOYOTA MOTOR ENGINEERING & MANUFACTURING NORTH AMERICA, INC., PLANO, TX (US)

(72) Inventors: Yuta Tsubaki, Mountain View, CA (US); Seyhan Ucar, Mountain View, CA (US); Emrah Akin Sisbot, Mountain View, CA (US); Xiaofei Cao, Mountain View, CA (US); Yongkang Liu, Mountain View, CA (US); Kentaro Oguchi, Mountain View, CA (US)

(73) Assignees: TOYOTA MOTOR ENGINEERING & MANUFACTURING NORTH AMERICA, INC., PLANO, TX (US); TOYOTA JIDOSHA KABUSHIKI KAISHA, TOYOTA-SHI (JP)

(21) Appl. No.: 18/942,131

(22) Filed: Nov. 8, 2024

Related U.S. Application Data
(60) Provisional application No. 63/699,568, filed on Sep. 26, 2024.

(51) Int. Cl. G06F 16/28; G06F 16/25

(52) U.S. Cl. CPC G06F 16/285; G06F 16/258

(57) ABSTRACT

A system includes sensors that determine one or more attributes associated with operation of a vehicle when the vehicle is in a operational status and to capture sensor data associated with operation of the vehicle. The system includes one or more datastores, one or more processors, and a memory storing instructions that, when executed by the one or more processors, cause the system to perform operations. The operations include obtaining the captured sensor data, inferring a hierarchical criteria to implement selective retaining of the obtained sensor data based on the obtained attributes, selectively retaining a subset of the obtained sensor data according to the inferred hierarchical criteria, reformatting the selectively retained subset of the obtained sensor data; and persisting the reformatted and selectively retained subset of the obtained sensor data to the one or more datastores.

### CROSS-REFERENCE TO RELATED APPLICATIONS

This application claims the benefit of U.S. Provisional Application No. 63/699,568 filed Sep. 26, 2024 and which is hereby incorporated herein by reference in its entirety.

### TECHNICAL FIELD

The present disclosure relates generally to identification and extraction of a subset of sensor data captured during operation of a vehicle, and in particular, some implementations may relate to computing architectures to retain and persist the extracted subset of sensor data.

### DESCRIPTION OF RELATED ART

During operation, sensors within or otherwise associated with vehicles capture and record large amounts of data. The data may include sensor data of captured scenes. The recorded sensor data may be useful for certain purposes, such as providing data for driver assistance systems which ultimately enhances vehicle safety. Attempting to permanently store all the recorded sensor data would overwhelm existing storage infrastructures. Additionally, even if the recorded sensor data could somehow be stored, retrieval of the recorded sensor data would be inefficient, and likely infeasible. Therefore, a portion of the recorded sensor data needs to be prioritized and identified to be retained.

Current approaches to select the portion of the recorded sensor data to be retained are largely inflexible. For example, fixed criteria such as certain thresholds or annotations may be used to determine which portion of the recorded sensor data is to be retained. These existing approaches have shortcomings because they may not be adaptable to different contexts. In such different contexts, different types of sensor data or scenes within the sensor data may be prioritized as important. For example, some contexts prioritize different perspectives such as a particular environment without emphasizing an individual vehicle, while other contexts may prioritize an individual vehicle instead of the overall environment. Moreover, the criteria to determine which types or scenes within the sensor data are to be prioritized may be variable, and may depend on dynamic factors such as environmental, weather, or traffic conditions. As yet another example, the different contexts may correspond to different users, who may have different priorities and intentions. The different contexts may, additionally or alternatively, correspond to different locations, which may prioritize different safety considerations and therefore different types or frames of sensor data.

### BRIEF SUMMARY OF THE DISCLOSURE

According to various embodiments of the disclosed technology, a system comprises one or more sensors configured to determine one or more attributes associated with operations of a vehicle when the vehicle is in an operational status and to capture sensor data associated with operation of the vehicle; one or more datastores; and one or more processors. The system comprises a memory storing instructions that, when executed by the one or more processors, cause the system to perform operations. The operations include obtaining the captured sensor data; inferring a hierarchical criteria to implement selective retaining of the obtained sensor data based on the obtained attributes; selectively retaining a subset of the obtained sensor data according to the inferred hierarchical criteria; reformatting the selectively retained subset of the obtained sensor data (e.g., to a compressed format such as a JPEG format); and persisting the reformatted and selectively retained subset of the obtained sensor data to the one or more datastores.

In some embodiments, the inferring of the hierarchical criteria to implement selective retaining of the obtained sensor data is further based on contextual information, the contextual information comprising feedback data when the vehicle is in a non-operational status (e.g., interaction with an external device that plays back the obtained sensor data at a later time when the vehicle is not navigating)

In some embodiments, the attributes comprise one or more indicators of unusual (e.g., anomalous) behavior of one or more occupants within the vehicle.

In some embodiments, the one or more indicators of unusual behavior are based on one or more head movements or gaze patterns of the one or more occupants within the vehicle (e.g., excessive head movements, staring intently). For example, the one or more indicators of unusual behavior may indicate that a current situation at that time is of interest, and therefore, captured sensor data at that time would also be of interest.

In some embodiments, the attributes are based on a steering angle of a steering wheel and a speed or an acceleration of the vehicle. For example, certain driving patterns that deviate from average driving patterns of surrounding traffic at that time may indicate that a current situation at that time is of interest, and therefore, captured sensor data at that time would also be of interest.

In some embodiments, the hierarchical criteria comprises a first set of criteria corresponding to first classifications within a first hierarchical level and a second set of criteria corresponding to second classifications within a second hierarchical level, wherein the second hierarchical level is associated with a higher level of granularity compared to the first hierarchical level. For example, first classifications may correspond to different cities if the first hierarchical level corresponds to “city.” Second classifications may correspond to different localities such as regions within a city, if the second hierarchical level corresponds to “locality.” The hierarchical criteria efficiently organizes the criteria because the criteria may differ depending on the first classifications (e.g., different cities) and the second classifications (e.g., different localities). For example, criteria for sensor data captured within city A may emphasize certain driving behaviors whereas criteria sensor data captured within city A may emphasize certain weather conditions.

In some embodiments, the selectively retaining a subset of the obtained sensor data according to the inferred hierarchical criteria comprises retrieving a specific criteria within the inferred hierarchical criteria corresponding to a first classification or a second classification that matches a characteristic of the obtained sensor data. For example, if the characteristic of the obtained sensor data is a location (e.g., city) at which the obtained sensor data is captured, then a specific criteria corresponding to that location is retrieved. The characteristic of the obtained sensor data may include a characteristic of a highest available level of specificity (e.g., street name if that is available) in order to obtain as specific and precise of a criteria as possible.

In some embodiments, the first hierarchical level and the second hierarchical level are based on locations.

In some embodiments, the instructions that, when executed by the one or more processors, cause the system to perform: transmitting the captured sensor data to a device; and wherein: the sensors are configured to obtain interaction data associated with the captured sensor data on the device; and the inferring of the hierarchical criteria is based on the interaction data.

In some embodiments, the obtained interaction data comprises a frequency of playback of a portion of the captured sensor data on the device.

In some embodiments, a vehicle control system, comprising: a processor; and a memory coupled to the processor to store instructions, which when executed by the processor, cause the processor to perform operations. The operations comprise obtaining captured sensor data from one or more sensors; obtaining one or more attributes associated with operation of a vehicle when the vehicle is in an operational status from the one or more sensors; inferring a hierarchical criteria to implement selective retaining of the obtained sensor data based on the obtained attributes; selectively retaining a subset of the obtained sensor data according to the inferred hierarchical criteria; reformatting the selectively retained subset of the obtained sensor data; and persisting the reformatted and selectively retained subset of the obtained sensor data to one or more datastores.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a schematic representation of an example hybrid vehicle with which embodiments of the systems and methods disclosed herein may be implemented.

FIG. 2 illustrates an example of an all-wheel drive hybrid vehicle with which embodiments of the systems and methods disclosed herein may be implemented.

FIG. 3 illustrates an example architecture for adaptively and selectively retaining sensor data, in accordance with one embodiment of the systems and methods described herein.

FIG. 4 illustrates an example architecture for adaptively and selectively retaining sensor data, in accordance with one embodiment of the systems and methods described herein, which may be implemented in conjunction with the example architecture illustrated in FIG. 3.

FIG. 5 is an example computing component that may be used to implement various features of embodiments described in the present disclosure.

The figures are not exhaustive and do not limit the present disclosure to the precise form disclosed.

### DETAILED DESCRIPTION

One or more sensors, such as cameras, Lidars, and/or radars, may capture and record sensor data, which may be stored within one or more remote servers. The sensors may be disposed on or within an ego vehicle, or disposed remotely from the ego vehicle, during operation of the ego vehicle. For example, the sensors may be from a different vehicle that is monitoring the ego vehicle. The sensor data may be recorded continuously, or in response to a trigger condition. The trigger condition may include an output of a driving assistance system, such as an Advanced Driver Assistance System (ADAS) deviating from an expected output by at least a threshold amount or extent, or other anomalous condition. The sensor data may include any or all of media data (e.g., image, video, and audio data) or time-series data.

From the sensor data, embodiments of the systems and methods disclosed herein can provide adaptive and selective extraction of sensor data of interest to be retained. The sensor data of interest may be identified as especially relevant to improve certain vehicle functionalities such as an ADAS, which ultimately enhances safety of the vehicle. The adaptive aspect of extraction of sensor data means that the extraction of sensor data is adapted to different contexts which are associated with different criteria to identify the sensor data of interest. For example, different criteria may be applied at different locations. The selective extraction of sensor data means that only the sensor data of interest is extracted, retained, and persisted in order to conserve a storage footprint. The selective extraction of sensor data also facilitates more efficient retrieval of the sensor data of interest.

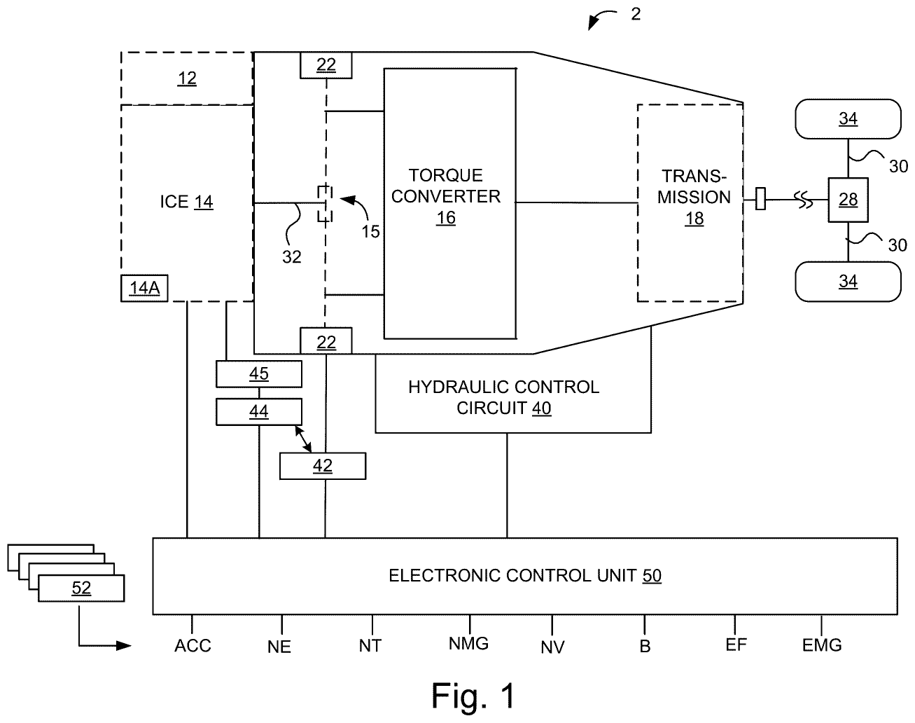

The systems and methods disclosed herein may be implemented with any of a number of different ego vehicles and ego vehicle types. For example, the systems and methods disclosed herein may be used with automobiles, trucks, motorcycles, recreational vehicles and other like on- or off-road vehicles. In addition, the principles disclosed herein may also extend to other vehicle types as well. An example hybrid electric vehicle (HEV) in which embodiments of the disclosed technology may be implemented as an ego vehicle and is illustrated in FIG. 1. Although the example described with reference to FIG. 1 is a hybrid type of ego vehicle, the systems and methods for adaptive and selective extraction of sensor data can be implemented in other types of ego vehicles including gasoline- or diesel-powered vehicles, fuel-cell vehicles, electric vehicles, or other vehicles.

FIG. 1 illustrates a drive system of an ego vehicle 2 that may include an internal combustion engine 14 and one or more electric motors 22 (which may also serve as generators) as sources of motive power. Driving force generated by the internal combustion engine 14 and motors 22 can be transmitted to one or more wheels 34 via a torque converter 16, a transmission 18, a differential gear device 28, and a pair of axles 30.

As an HEV, ego vehicle 2 may be driven/powered with either or both of engine 14 and the motor(s) 22 as the drive source for travel. For example, a first travel mode may be an engine-only travel mode that only uses internal combustion engine 14 as the source of motive power. A second travel mode may be an EV travel mode that only uses the motor(s) 22 as the source of motive power. A third travel mode may be an HEV travel mode that uses engine 14 and the motor(s) 22 as the sources of motive power. In the engine-only and HEV travel modes, ego vehicle 2 relies on the motive force generated at least by internal combustion engine 14, and a clutch 15 may be included to engage engine 14. In the EV travel mode, ego vehicle 2 is powered by the motive force generated by motor 22 while engine 14 may be stopped and clutch 15 disengaged.

Engine 14 can be an internal combustion engine such as a gasoline, diesel or similarly powered engine in which fuel is injected into and combusted in a combustion chamber. A cooling system 12 can be provided to cool the engine 14 such as, for example, by removing excess heat from engine 14. For example, cooling system 12 can be implemented to include a radiator, a water pump and a series of cooling channels. In operation, the water pump circulates coolant through the engine 14 to absorb excess heat from the engine. The heated coolant is circulated through the radiator to remove heat from the coolant, and the cold coolant can then be recirculated through the engine. A fan may also be included to increase the cooling capacity of the radiator. The water pump, and in some instances the fan, may operate via a direct or indirect coupling to the driveshaft of engine 14. In other applications, either or both the water pump and the fan may be operated by electric current such as from battery 44.

An output control circuit 14A may be provided to control drive (output torque) of engine 14. Output control circuit 14A may include a throttle actuator to control an electronic throttle valve that controls fuel injection, an ignition device that controls ignition timing, and the like. Output control circuit 14A may execute output control of engine 14 according to a command control signal(s) supplied from an electronic control unit 50, described below. Such output control can include, for example, throttle control, fuel injection control, and ignition timing control.

Motor 22 can also be used to provide motive power in ego vehicle 2 and is powered electrically via a battery 44. Battery 44 may be implemented as one or more batteries or other power storage devices including, for example, lead-acid batteries, nickel-metal hydride batteries, lithium ion batteries, capacitive storage devices, and so on. Battery 44 may be charged by a battery charger 45 that receives energy from internal combustion engine 14. For example, an alternator or generator may be coupled directly or indirectly to a drive shaft of internal combustion engine 14 to generate an electrical current as a result of the operation of internal combustion engine 14. A clutch can be included to engage/disengage the battery charger 45. Battery 44 may also be charged by motor 22 such as, for example, by regenerative braking or by coasting during which time motor 22 operate as generator.

Motor 22 can be powered by battery 44 to generate a motive force to move the vehicle and adjust vehicle speed. Motor 22 can also function as a generator to generate electrical power such as, for example, when coasting or braking. Battery 44 may also be used to power other electrical or electronic systems in the vehicle. Motor 22 may be connected to battery 44 via an inverter 42. Battery 44 can include, for example, one or more batteries, capacitive storage units, or other storage reservoirs suitable for storing electrical energy that can be used to power motor 22. When battery 44 is implemented using one or more batteries, the batteries can include, for example, nickel metal hydride batteries, lithium ion batteries, lead acid batteries, nickel cadmium batteries, lithium ion polymer batteries, and other types of batteries.

An electronic control unit 50 (described below) may be included and may control the electric drive components of the vehicle as well as other vehicle components. For example, electronic control unit 50 may control inverter 42, adjust driving current supplied to motor 22, and adjust the current received from motor 22 during regenerative coasting and breaking. As a more particular example, output torque of the motor 22 can be increased or decreased by electronic control unit 50 through the inverter 42.

A torque converter 16 can be included to control the application of power from engine 14 and motor 22 to transmission 18. Torque converter 16 can include a viscous fluid coupling that transfers rotational power from the motive power source to the driveshaft via the transmission. Torque converter 16 can include a conventional torque converter or a lockup torque converter. In other embodiments, a mechanical clutch can be used in place of torque converter 16.

Clutch 15 can be included to engage and disengage engine 14 from the drivetrain of the vehicle. In the illustrated example, a crankshaft 32, which is an output member of engine 14, may be selectively coupled to the motor 22 and torque converter 16 via clutch 15. Clutch 15 can be implemented as, for example, a multiple disc type hydraulic frictional engagement device whose engagement is controlled by an actuator such as a hydraulic actuator. Clutch 15 may be controlled such that its engagement state is complete engagement, slip engagement, and complete disengagement complete disengagement, depending on the pressure applied to the clutch. For example, a torque capacity of clutch 15 may be controlled according to the hydraulic pressure supplied from a hydraulic control circuit 40. When clutch 15 is engaged, power transmission is provided in the power transmission path between the crankshaft 32 and torque converter 16. On the other hand, when clutch 15 is disengaged, motive power from engine 14 is not delivered to the torque converter 16. In a slip engagement state, clutch 15 is engaged, and motive power is provided to torque converter 16 according to a torque capacity (transmission torque) of the clutch 15.

As alluded to above, ego vehicle 2 may include an electronic control unit 50. Electronic control unit 50 may include circuitry to control various aspects of the vehicle operation. Electronic control unit 50 may include, for example, a microcomputer that includes a one or more processing units (e.g., microprocessors), memory storage (e.g., RAM, ROM, etc.), and I/O devices. The processing units of electronic control unit 50 execute instructions stored in memory to control one or more electrical systems or subsystems in the vehicle. Electronic control unit 50 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS or ESC), battery management systems, and so on. These various control units can be implemented using two or more separate electronic control units, or using a single electronic control unit.

In the example illustrated in FIG. 1, electronic control unit 50 receives information from a plurality of sensors included in ego vehicle 2. For example, electronic control unit 50 may receive signals that indicate vehicle operating conditions or characteristics, or signals that can be used to derive vehicle operating conditions or characteristics. These may include, but are not limited to accelerator operation amount, ACC, a revolution speed, NE, of internal combustion engine 14 (engine RPM), a rotational speed, NMG, of the motor 22 (motor rotational speed), and vehicle speed, NV. These may also include torque converter 16 output, NT (e.g., output amps indicative of motor output), brake operation amount/pressure, B, battery SOC (i.e., the charged amount for battery 44 detected by an SOC sensor). Accordingly, ego vehicle 2 can include a plurality of sensors 52 that can be used to detect various conditions internal or external to the vehicle and provide sensed conditions to engine control unit 50 (which, again, may be implemented as one or a plurality of individual control circuits). In one embodiment, sensors 52 may be included to detect one or more conditions directly or indirectly such as, for example, fuel efficiency, EF, motor efficiency, EMG, hybrid (internal combustion engine 14+cooling system 12) efficiency, acceleration, ACC, etc. Electronic control unit 50 may also receive signals indicative of user behavior. Here, a user may refer to an occupant, such as a driver or a passenger. These signals may include, without limitation, a measure of head or eye movement.

In some embodiments, one or more of the sensors 52 may include their own processing capability to compute the results for additional information that can be provided to electronic control unit 50. In other embodiments, one or more sensors may be data-gathering-only sensors that provide only raw data to electronic control unit 50. In further embodiments, hybrid sensors may be included that provide a combination of raw data and processed data to electronic control unit 50. Sensors 52 may provide an analog output or a digital output.

Sensors 52 may be included to detect not only vehicle conditions but also to detect external conditions as well. Sensors that might be used to detect external conditions can include, for example, sonar, radar, lidar or other vehicle proximity sensors, and cameras or other image sensors. Image sensors can be used to detect, for example, traffic signs indicating a current speed limit, road curvature, obstacles, and so on. Still other sensors may include those that can detect road grade. While some sensors can be used to actively detect passive environmental objects, other sensors can be included and used to detect active objects such as those objects used to implement smart roadways that may actively transmit and/or receive data or other information.

The sensors 52 may be within an interior or on an exterior of the ego vehicle 2. The sensors 52 may also include capturing sensors, which capture sensor data within the ego vehicle 2 or within surroundings of the ego vehicle 2. In some embodiments, additional sensors may not be directly connected to the ego vehicle 2, but rather, may be located on a different entity, such as a drone or a stationary landmark such as a traffic light.

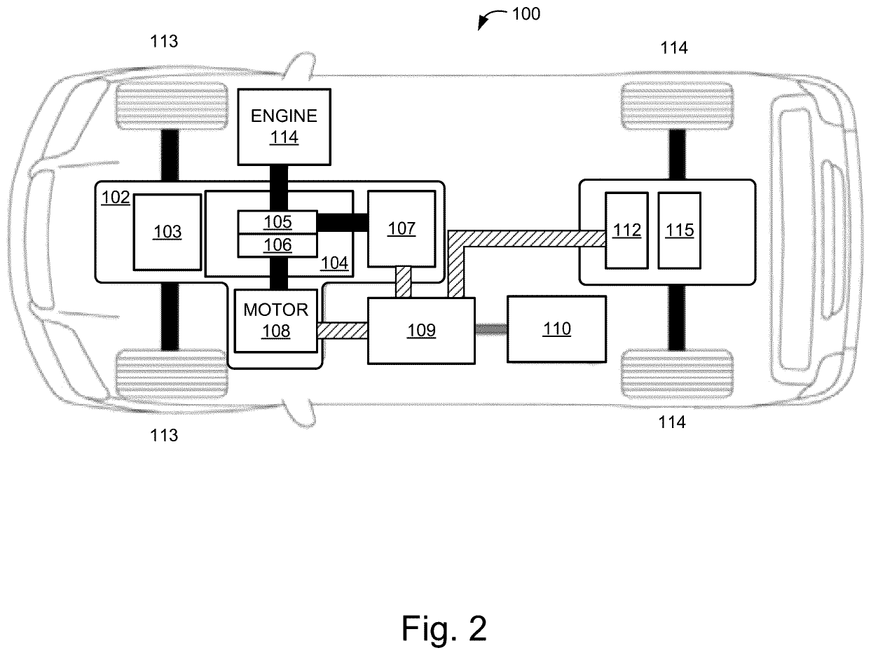

FIG. 2 is another example of an ego vehicle with which systems and methods for adaptive and selective extraction of sensor data can be implemented. The example illustrated in FIG. 2 is also that of a hybrid vehicle drive system of a vehicle 100 that may also include an engine 114 (e.g., internal combustion engine 14) and one or more electric motors 108, 112 (e.g., motors 22) as sources of motive power. In this example, a hybrid transaxle assembly 102 includes front differential 103, a compound gear unit 104, a motor 108, and a generator 107. Compound gear unit 104 includes a power split planetary gear unit 105 and a motor speed reduction planetary gear unit 106. This example vehicle also includes front and rear drive motors 108, 112, an inverter with converter assembly 109, battery 110 (which may include multiple batteries), and a rear differential 115. Hybrid transaxle assembly 102 enables power from engine 101, motor 108, or both to be applied to front wheels 113 via front differential 103.

Inverter with converter assembly 109 inverts DC power from battery 110 to create AC power to drive AC motors 108, 112. In embodiments where motors 108, 112 are DC motors, no inverter is required. Inverter with converter assembly 109 also accepts power from generator 107 (e.g., during engine charging) and uses this power to charge battery 110.

The examples of FIGS. 1 and 2 are provided for illustration purposes only as examples of vehicle systems with which embodiments of the disclosed technology may be implemented. One of ordinary skill in the art reading this description will understand how the disclosed embodiments can be implemented with vehicle platforms.

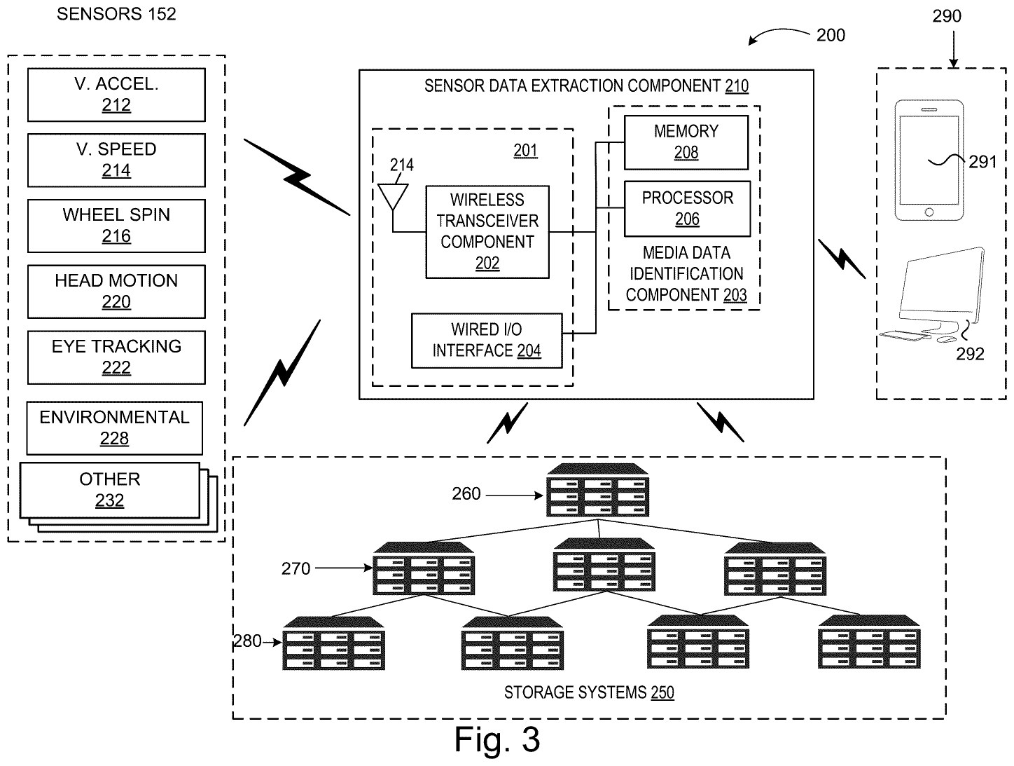

FIG. 3 illustrates an example architecture for adaptively and selectively extracting a subset of sensor data such as media data or time-series data, which may be captured at least in part by sensors 52 illustrated in FIG. 1, in accordance with one embodiment of the systems and methods described herein. Referring now to FIG. 3, in this example, sensor data extraction system 200 includes a sensor data extraction component 210, a plurality of sensors 152, a plurality of storage systems 250 which may include remote servers, and one or more other devices 290 which may external or internally located within the vehicle 2, or external to the sensor data extraction component 210. Sensors 152, storage systems 250, and one or more other devices 290 can communicate with sensor data extraction component 210 via a wired or wireless communication interface. Although sensors 152, storage systems 250 and one or more other devices 290 are depicted as communicating with sensor data extraction component 210, they can also communicate with each other as well as with other vehicle systems. In some embodiments, the one or more other devices 290 include one or more different computing or mobiles devices 291 and 292, and may be configured to receive a subset (e.g., a portion or all of) sensor data either in real-time or in a delayed manner via Vehicle-to-Network (V2N) communication, and either while the ego vehicle 2 is in the process of operation or not during operation of the ego vehicle 2. As will be further explained in FIG. 3, the one or more other devices 290 may provide contextual information, or feedback, regarding criteria to determine which of the sensor frames are to be retained.

Sensors 152 can include, for example, sensors 52 such as those described above with reference to the example of FIG. 1. Sensors 152 can include additional sensors. In the illustrated example, sensors 152 may obtain operation and/or other related data such as behavioral and/or interaction data of occupants within the ego vehicle 2. The sensors 152 may include vehicle acceleration sensors 212, vehicle speed sensors 214, wheelspin sensors 216 (e.g., one for each steering wheel), head motion sensors 220 to detect rotational and/or translational motion of a head of a user (e.g., a driver and/or passenger within the ego vehicle 2), eye tracking sensors 222 to detect eye movements of the user, and environmental sensors 228 (e.g., to detect traffic density, speed of surrounding traffic, weather, air quality, and/or other environmental conditions). Additional sensors 232 can also be included as may be appropriate for a given implementation of sensor data extraction system 200. The sensors 152 may be configured to detect and/or alert for any indications of unusual behavior, as will be described below.

Storage systems 250 may include one or more remote servers. The remote servers may be arranged and indexed in a hierarchical fashion to store one or more actual or inferred criteria of determining sensor data of interest and/or associated metadata. The one or more criteria may correspond to one or more different users, and may be classified or organized (hereinafter “classified”) at or according to different hierarchical levels. For example, the storage systems 250 may include one or more hierarchical levels 260, 270, and 280 of servers, which are configured to store one or more criteria corresponding to different hierarchical levels. In some embodiments, the hierarchical levels 260, 270, and 280 may include geographical classifications of increasing specificity or granularity, such as different cities, localities (e.g., region or area within the city), and streets, intersections, or addresses (hereinafter “streets”). For example, the hierarchical level 260 may be the lowest granularity level and configured to store one or more criteria of “city” classifications. The hierarchical level 270 may be configured to store one or more criteria of “locality” classifications. The hierarchical level 280 may be the highest granularity level and configured to store one or more criteria of “street” classifications.

As specific illustrative examples, in city A, criteria stored within the hierarchical levels 260 may include inclement weather conditions or adverse environmental conditions (e.g., air quality fails to satisfy some level) and situations in which lane changing or turning are occurring, because such situations may be especially dangerous in city A. Within locality B of city A, the criteria may be more specific and include rainy or foggy conditions, and the situations may include more specific types of lane changing. Within street C of locality B, the criteria may be even more specific and include conditions in which rain is falling at a threshold rate, and/or amount of fog exceeds some threshold. Thus, moving from city to locality to street, the criteria may be more specific. Locality may inherit the criteria of city, and street may inherit the criteria of both locality and city. Other cities, localities, and streets may have different criteria. In some embodiments, if criteria within a street is unavailable, then the applied criteria at that street for determining which sensor data to be retained would correspond to a lowest level applicable criteria available. For example, if criteria within street F is unavailable, then criteria within a locality to which street F belongs would be applied, if available. If criteria within the locality is unavailable, then criteria within a city to which street F belongs would be applied.

Related metadata may also be stored within the storage systems 250. Metadata may include reasons or bases upon which a criteria is inferred (e.g., navigation related data indicative of abnormal gestures or abnormal navigation, or a selection or textual prompt received from the one or more other devices 290). Metadata may include whether a criteria has been verified and/or a confidence level of the criteria.

Other embodiments in which different hierarchical levels, different types of hierarchical levels (e.g., weather-based, traffic based, vehicle type based, or based on other characteristics) or different numbers of hierarchical levels besides three levels are also contemplated. For example, the criteria may depend on weather conditions. As a specific illustrative example, under rainy conditions, a criteria to select which sensor data to retain may include any situations in which lane changes occur. As more detailed criteria, within different ranges of rainfall, the criteria may include different types of lane changes while excluding other types of lane changes. For example, if rainfall is between 0.5″ and 1″, then the criteria may include any lane changes in which signaling did not occur prior to the lane change. If rainfall is over 1″, the criteria may include any lane changes regardless of whether signaling occurred. In some embodiments, a combination of criteria including geographical based criteria and environmental based criteria may be applied.

In some embodiments, the storage systems 250 may be implemented as a single server or distributed server. The single server may implement tiered storage to store criteria corresponding to the different hierarchical levels.

In some embodiments, the storage systems 250 may be configured to store sensor data captured during operation, which may be received via V2N communication. In some embodiments, the sensor data may be stored in a different video server.

Sensor data extraction component 210 can be implemented as an ECU or as part of an ECU such as, for example electronic control unit 50. In other embodiments, sensor data extraction component 210 can be implemented independently of the ECU.

Sensor data extraction component 210 in this example includes a communication component 201, and a sensor data identification component 203 (including a processor 206 and memory 208 in this example). Components of sensor data extraction component 210 are illustrated as communicating with each other via a data bus, although other communication in interfaces can be included.

The sensor data identification component 203 can receive input information and contextual information. The input information and the contextual information can indicate or otherwise be used to infer one or more criterion to be applied in prioritizing certain portions or aspects of the sensor data to be retained and persisted. The sensor data identification component 203 can infer one or more criterion from the input information and the contextual information. In some embodiments, the sensor data identification component 203 may obtain input information, indicative of attributes, from the sensors 152 during operation. The sensor data identification component 203 may identify, from the input information, any indications of unusual behavior, or otherwise be alerted, by the sensors 152, of any indications of unusual behavior. In some embodiments, unusual behavior may include anomalous gestures or interactions (hereinafter “gestures”) exhibited by the user during operation. This unusual behavior may signify a user intent because of a heightened level of awareness or attention, and consequently, may indicate that sensor data captured at a time of or overlapping with the unusual behavior is of interest to the user. Example indications of anomalous gestures may include excessive head motion, anomalous gaze patterns, and/or other anomalous body movements. Excessive head motion may encompass an amount or a rate of translational or rotational head motion exceeding a threshold amount or rate. The threshold amount or rate may be set based on the user's historical behavior or a baseline. For example, the threshold amount or rate may be set such that at least a given proportion of the time, the user's behavior falls within the threshold amount and/or rate. The given proportion may be 99 percent, 98 percent, 95 percent, 90 percent, 80 percent, or any other suitable proportion, or any value therebetween. In some embodiments, the sensor data identification component 203 may, additionally or alternatively, identify unusual operation data from the sensors 152. Similar to unusual behavior, unusual operation data may also indicate a heightened level of awareness of the user, and that sensor data captured at that time should be retained. Unusual operation data may include certain navigation actions that deviate from behavior of surrounding traffic and/or that is unlikely to be attributed to traffic and/or environmental conditions (e.g., weather, visibility). For example, unusual operation data may include slowing down the ego vehicle 2 to a speed that is at least a threshold amount or proportion below an average speed of surrounding traffic. As another example, unusual operation data may include excessive wheel or tire rotation that exceeds an average wheel or tire rotation of surrounding traffic by at least a threshold amount or proportion of rotation.

Input information may also include activities with a cabin of the ego vehicle 2, such as interactions by an occupant with the sensor data during operation. The sensor data may be played on the one or more other devices 290 within the ego vehicle 2. Interactions may include taking screenshots of portions of the sensor data played on the one or more other devices 290, repeatedly playing specific segments of the sensor data, and/or disabling active ADAS features in favor of manual control. These interactions, when the ego vehicle 2 is at a particular location, may indicate that the portions of sensor data interacted with are of interest to the occupant. Input information may further include selections or annotations (hereinafter “selections”) of frames or portions of sensor data received from the one or more other devices 290. In some embodiments, contextual information may include one or more textual prompts, queries or descriptions (hereinafter “textual prompts”) received from the one or more other devices 290.

In some embodiments, contextual information may include playback, repeated playback that has occurred at a threshold frequency and/or a threshold duration, and/or other parameters associated with the playback such as a playback speed. For example, playback of a particular frame of sensor data, such as playback of the particular frame at least a threshold number of times (e.g., 2 or more times) or of at least a threshold duration may indicate that the frame constitutes sensor data of interest. Certain other actions during viewing or playback may also constitute contextual information. These other actions may include pausing a video or portion thereof within the sensor data, or slowing down the video or portion thereof, which may further indicate that a particular frame constitutes sensor data of interest.

In some embodiments, the textual prompts may be associated or linked with criteria corresponding to a “city” classification, the selections of particular frames or portions may be associated or linked with criteria corresponding to a “locality” classification, and the indicators of abnormal behavior from the one or more sensors 152 may be associated or linked with criteria corresponding to a “street” classification. However, other embodiments are also contemplated.

When the sensor data identification component 203 identifies unusual behavior or other input information such as interactions, the sensor data identification component 203 may identify corresponding frames of sensor data captured at a same or overlapping time. For example, if the sensor data identification component 203 identifies unusual behavior at a time period between 1:00 PM and 1:05 PM, the sensor data identification component 203 identifies corresponding frames of sensor data that were at least partially captured during that time period. The sensor data identification component 203 may indicate the identified corresponding frames are to be retained. Alternatively, the sensor data identification component 203 may indicate the identified corresponding frames as candidate frames to potentially be retained. In some embodiments, the sensor data identification component 203 may identify one or more characteristics of the corresponding frames, such as a most frequently occurring characteristic or otherwise characteristics based on frequencies of occurrence, within the corresponding frames. The sensor data identification component 203 may identify one or more additional frames having similar characteristics. The sensor data identification component 203 may identify the additional frames using time series analysis and/or supervised or unsupervised machine learning algorithms such as clustering. These additional frames may also be identified to be retained, or as candidate frames to potentially be retained. For example, assume that a common characteristic occurring in at least a threshold proportion of the corresponding frames is a presence of certain traffic or environmental condition (e.g., a vehicle driving in the wrong direction). From the common characteristic, the sensor data identification component 203 may infer that the common characteristic is a criteria for the sensor data to be retained. The sensor data identification component 203 may then identify additional frames or additional candidate frames to be retained, based on the inferred criteria. These additional frames or additional candidate frames may also have the common characteristic, in which the certain traffic or environmental condition is present. As yet another example, a common characteristic occurring in at least a threshold proportion of the corresponding frames may be that a certain vehicle (e.g., the ego vehicle 2 or a different vehicle) has activated or deactivated certain vehicle functionalities (e.g., anti-lock braking system (ABS)) and/or is attempting or completing a certain maneuver (e.g., an evasive maneuver).

The previous discussion focused on the sensor data identification component 203 identifying unusual behavior from sensors 152 or other interactions during operation. Additionally or alternatively, the sensor data identification component 203 may infer criteria of retaining sensor data of interest based on contextual information which may include feedback information when the ego vehicle 2 is not actively navigating. For example, the sensor data identification component 203 may receive feedback from the one or more other devices 290, which may have received the captured sensor data and are disposed away from the ego vehicle 2.

The one or more other devices 290 may have received the captured sensor data, and may be in communication with the sensor data identification component 203. The contextual information may be obtained when the ego vehicle 2 is not actively navigating. In some embodiments, the contextual information from the one or more other devices 290 may include same or similar information as that previously described regarding the interactions with the one or more other devices 290 in the cabin of the ego vehicle 2.

The sensor data identification component 203 may infer one or more common features from the one or more selections. In some embodiments, sensor data identification component 203 may identify one or more additional frames based on the one or more common features. In some embodiments, sensor data identification component 203 may identify one or more additional frames having at least a threshold level of similarity with the one or more selections. In some embodiments, sensor data identification component 203 may identify one or more additional frames that satisfy at least a threshold degree of matching with the one or more textual prompts. The inferences may be based on locations corresponding to the captured sensor data.

As an illustrative example, the sensor data identification component 203 may obtain selections of frames captured in city A, which all include a scenario of a vehicle making a lane change without a signal. The sensor data identification component 203 may infer that in city A, the criteria of selecting which sensor data frames are to be retained includes the presence of a vehicle making a lane change without a signal. The sensor data identification component 203 may identify additional frames captured in city A that also include the presence of a vehicle making a lane change without a signal.

Once frames are selected for retention, either based on contextual information from the one or more other devices 290 or based on input information during operation, the frames may be stored in one or more datastores. The datastores may include the storage systems 250 and/or other datastores. The frames may be stored in different formats such as compressed formats (e.g., Joint Photographic Experts Group (JPEG) formats).

Processor 206 can include one or more GPUs, CPUs, microprocessors, or any other suitable processing system. Processor 206 may include a single core or multicore processors. The memory 208 may include one or more various forms of memory or data storage (e.g., flash, RAM, etc.) that may be used to store any information used to infer a criteria for extracting a subset of sensor data, for processor 206 as well as any other suitable information. Memory 208, can be made up of one or more modules of one or more different types of memory, and may be configured to store data and other information as well as operational instructions that may be used by the processor 206.

Although the example of FIG. 3 is illustrated using processor and memory components, as described below with reference to components disclosed herein, sensor data identification component 203 can be implemented utilizing any form of circuitry including, for example, hardware, software, or a combination thereof. By way of further example, one or more processors, controllers, ASICs, PLAS, PALs, CPLDs, FPGAs, logical components, software routines or other mechanisms might be implemented to make up sensor data extraction component 210.

Communication component 201 includes either or both a wireless transceiver component 202 with an associated antenna 205 and a wired I/O interface 204 with an associated hardwired data port (not illustrated). As this example illustrates, communications with sensor data extraction component 210 can include either or both wired and wireless communication components 201. Wireless transceiver component 202 can include a transmitter and a receiver (not shown) to allow wireless communications via any of a number of communication protocols such as, for example, Wifi, Bluetooth, near field communications (NFC), Zigbee, and any of a number of other wireless communication protocols whether standardized, proprietary, open, point-to-point, networked or otherwise. Antenna 214 is coupled to wireless transceiver component 202 and is used by wireless transceiver component 202 to transmit radio signals wirelessly to wireless equipment with which it is connected and to receive radio signals as well. These RF signals can include information of almost any sort that is sent or received by sensor data extraction component 210 to/from other entities such as sensors 152 and storage systems 250.

Wired I/O interface 204 can include a transmitter and a receiver (not shown) for hardwired communications with other devices. For example, wired I/O interface 204 can provide a hardwired interface to other components, including sensors 152 and storage systems 250. Wired I/O interface 204 can communicate with other devices using Ethernet or any of a number of other wired communication protocols whether standardized, proprietary, open, point-to-point, networked or otherwise.

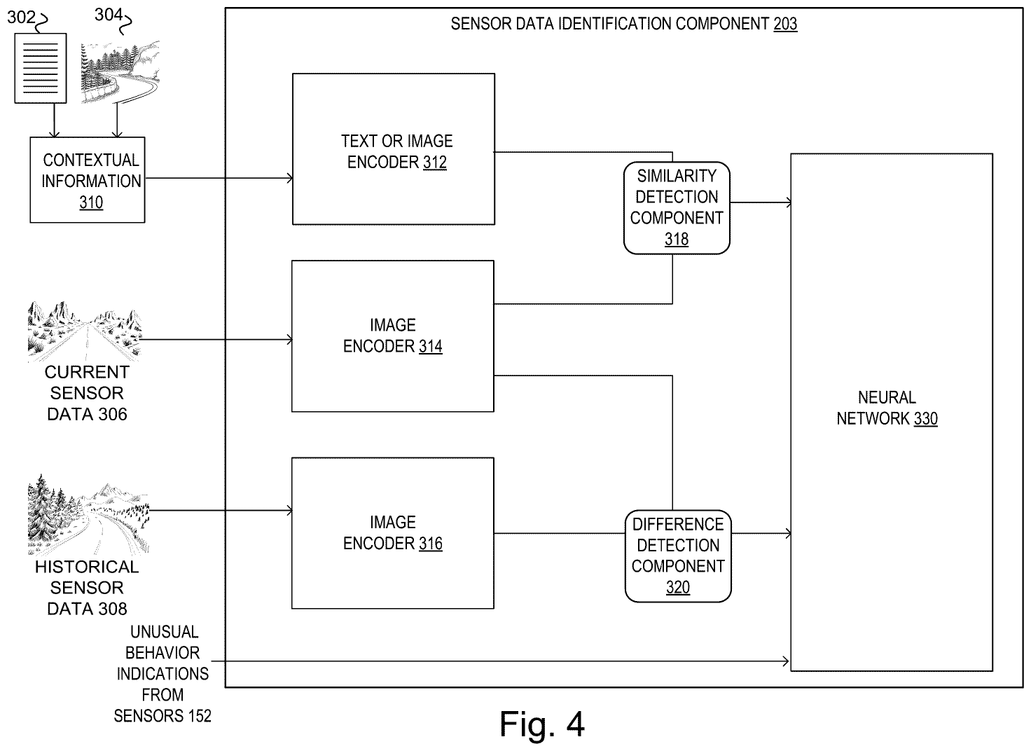

FIG. 4 illustrates another perspective of implementation of the sensor data identification component 203. In some embodiments, the principles in FIG. 4 may be applied in conjunction with FIG. 3. In FIG. 4, the sensor data identification component 203 includes any of a text and/or image encoder (hereinafter “encoder”) 312, an image encoder 314, an image encoder 316, a similarity detection component 318, a difference detection component 320, and a neural network 330.

The encoder 312 may obtain contextual information 310, which may include or may be derived based on textual prompts 302 and/or from one or more selections 304 of sensor data frames, as described with respect to FIG. 3. The contextual information 310 may be indicative of one or more criteria applied to determine which frames of sensor data are to be retained. The encoder 312 may transform the contextual information 310 into a different format or representation, such as a different feature space. Meanwhile, the image encoder 314 may obtain current (e.g., real-time) sensor data 306 to be evaluated against the contextual information 310, in order to determine whether any of the current sensor data 306 is to be retained. For example, each individual frame of the current sensor data 306 may be evaluated against each textual prompt 302 and each selection 304. In some embodiments, the current sensor data 306 refers to any sensor data that has not yet been evaluated to determine whether or not any portion thereof is to be retained. The image encoder 314 may transform the current sensor data 306 into a different format or representation, in order to facilitate comparison between the transformed representation of the current sensor data 306 and the transformed representation of the contextual information 310.

The similarity detection component 318 may determine a degree of similarity (e.g., a cosine similarity) between each individual feature (e.g., a textual prompt 302 or portion thereof, or frame corresponding to a selection 304) corresponding to the transformed contextual information and each individual current frame. If the degree of similarity of any current frame and an individual feature satisfies some threshold level, then the current frame likely is of interest and may be selected to be retained or as a candidate to potentially be retained. In other embodiments, instead of comparison between each individual feature and each individual frame, a combination of features may be compared against an individual frame or a combination of frames. In other embodiments, an individual feature may be compared against a combination of frames.

As an illustrative example, N text features x may be obtained using CLIP text encoder fₜₑₓₜ and 4 image features y using CLIP image encoder f_{image}. The cosine similarity of features between the every text feature and each image is calculated and a maximum cosine similarity Sim(x, y) is obtained, as shown in Equation 1 below.

$$Sim ( x , y ) = max ( cos ( {f}_{text} ( {x}_{i} ) , {f}_{image} ( {y}_{j} ) ) ) , where 1 \leq i \leq N , 5 \leq j \leq 8 \qquad ( 1 )$$

The image encoder 316 may obtain historical sensor data 308, which includes one or more previous scenes compared to the current sensor data 306. For example, the historical sensor data 308 may include immediately preceding scenes relative to the current sensor data 306. The image encoder 316 may transform the historical sensor data 308 into a different format or representation, in order to facilitate comparison between each individual frame of the transformed representation of the current sensor data 306 and each individual frame of the transformed representation of the historical sensor data 308. The difference detection component 320 determines a degree of difference (e.g., based on a cosine similarity) between any two consecutive instances of captured sensor data, such as between two consecutive images or two consecutive frames. One example of a difference between two consecutive frames occurs when a pedestrian suddenly appears in the current sensor data 306, but was absent from the historical sensor data 308.

As an illustrative example, features from consecutive images, consisting of 4 images of the current scene (e.g., the current sensor data 306) and 4 images of the previous scene (e.g., the historical sensor data 308) are obtained using a CLIP image encoder, according to Equation 2 below

$$C ( yj + 4 , yj ) = {\sum }_{j = 1}^{N = 4} cos ( fimage ( yj + 4 ) , fimage ( yj ) ) \qquad ( 2 )$$

To compensate to high values in situations of right or left turns, even when consecutive scenes do not change significantly, a steering wheel value may be set to zero when turning left or right.

In some embodiments, the historical sensor data 308 may also include previous frames of sensor data that have been determined to satisfy the criteria for retaining. The difference detection component 320 determines a degree of difference according to a cosine similarity between any individual frame corresponding to the current sensor data 306 and any individual frame corresponding to the historical sensor data 308. If a difference fails to satisfy a threshold level of difference, that means that at least a portion of the current sensor data 306 is sufficiently similar to at least a portion of the historical sensor data 308 which has already been evaluated. In that situation, the current sensor data 306 may not be retained in order to conserve storage, because retaining the current sensor data 306 would likely result in redundancy with previous frames.

The neural network 330 may predict a score indicative of a level of priority of a frame of the current sensor data 306 which corresponds to a probability that the current sensor data 306 satisfies the criteria. The neural network may infer whether or not to retain the current sensor data 306. The neural network 330 may retain a frame of the current sensor data 306 if the similarity detection component 318 detects at least a threshold level of similarity between any feature or combination of features within the contextual information 310 and the frame of the current sensor data 306, and the difference detection component 320 detects at least a threshold level of difference between the frame of the current sensor data 306 and historical frames corresponding to the historical sensor data 308.

As previous explained with respect to FIG. 3, the neural network 330 also determines whether any frames of the current sensor data 306 are to be retained based on indications of unusual behavior from the sensors 152. Here, the indications of unusual behavior may be based on wheel steering data of the ego vehicle 2, speed data of the ego vehicle 2, and/or acceleration data of the ego vehicle 2, along with indications of other unusual behaviors. The neural network may normalize each input (e.g., similarity measure from the similarity detection component 318, difference measure from the difference detection component 320, indications of unusual behavior) and transforms the result into a tensor (e.g., a three-dimensional tensor), combines the tensor along a third axis and outputs a softmax score indicating an inferred importance of the current frame or portion of the sensor data. The neural network may include a 4-layer multi-layer perceptron (MLP) with a ReLU non-linearity, dropout 0.5 between 2 and 3 layer and dropout 0.2 between 3 and 4 layer. Each feature is also normalized between each layer.

The neural network 330 may be iteratively trained, for example, based on feedback regarding the retained portions or frames of the sensor data. In some embodiments, the feedback may include interactions with the retained portions of the sensor data, include taking screenshots, replaying, or stopping the retained portions of the sensor data. For example, a frequency indicating a number of times a portion of the sensor data is replayed on the one or more other devices 290, and/or a duration at which a portion of the sensor data is stopped, may be indicative of an actual level of interest of that portion of the sensor data. If the portion of the sensor data is replayed a high number of times (e.g. at least two times) or is stopped frequently and/or for a long duration of time, then the feedback may be that the portion of the sensor data is confirmed to be of high interest. In this manner, the neural network may iteratively learn from the feedback and improve its identification of criteria in determining which portions of sensor data to be retained.

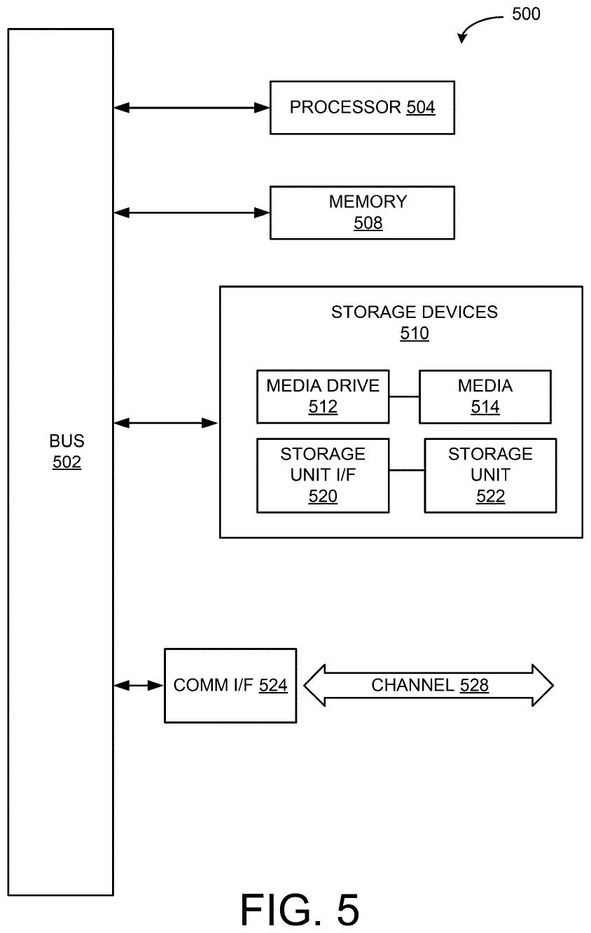

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 5. Various embodiments are described in terms of this example-computing component 500. After reading this description, it will become apparent to a person skilled in the relevant art how to implement the application using other computing components or architectures.

Referring now to FIG. 5, computing component 500 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 500 might also represent computing capabilities embedded within or otherwise available to a given device. For example, a computing component might be found in other electronic devices such as, for example, portable computing devices, and other electronic devices that might include some form of processing capability.

Computing component 500 might include, for example, one or more processors, controllers, control components, or other processing devices. This can include a processor, and/or any one or more of the components. Processor 504 might be implemented using a general-purpose or special-purpose processing engine such as, for example, a microprocessor, controller, or other control logic. Processor 504 may be connected to a bus 502. However, any communication medium can be used to facilitate interaction with other components of computing component 500 or to communicate externally.

Computing component 500 might also include one or more memory components, simply referred to herein as main memory 508. For example, random access memory (RAM) or other dynamic memory, might be used for storing information and instructions to be executed by processor 504. Main memory 508 might also be used for storing temporary variables or other intermediate information during execution of instructions to be executed by processor 504. Computing component 500 might likewise include a read only memory (“ROM”) or other static storage device coupled to bus 502 for storing static information and instructions for processor 504.

The computing component 500 might also include one or more various forms of information storage mechanism 510, which might include, for example, a media drive 512 and a storage unit interface 520. The media drive 512 might include a drive or other mechanism to support fixed or removable storage media 514. For example, a hard disk drive, a solid-state drive, a magnetic tape drive, an optical drive, a compact disc (CD) or digital video disc (DVD) drive (R or RW), or other removable or fixed media drive might be provided. Storage media 514 might include, for example, a hard disk, an integrated circuit assembly, magnetic tape, cartridge, optical disk, a CD or DVD. Storage media 514 may be any other fixed or removable medium that is read by, written to or accessed by media drive 512. As these examples illustrate, the storage media 514 can include a computer usable storage medium having stored therein computer software or data.

In alternative embodiments, information storage mechanism 510 might include other similar instrumentalities for allowing computer programs or other instructions or data to be loaded into computing component 500. Such instrumentalities might include, for example, a fixed or removable storage unit 522 and an interface 520. Examples of such storage units 522 and interfaces 520 can include a program cartridge and cartridge interface, a removable memory (for example, a flash memory or other removable memory component) and memory slot. Other examples may include a PCMCIA slot and card, and other fixed or removable storage units 522 and interfaces 520 that allow software and data to be transferred from storage unit 522 to computing component 500.

Computing component 500 might also include a communications interface 524. Communications interface 524 might be used to allow software and data to be transferred between computing component 500 and external devices. Examples of communications interface 524 might include a modem or soft modem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 524 may be carried on signals, which can be electronic, electromagnetic (which includes optical) or other signals capable of being exchanged by a given communications interface 524. These signals might be provided to communications interface 524 via a channel 528. Channel 528 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 508, storage unit 520, media 514, and channel 528. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 500 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Reference to A “and” B may be construed to also encompass the scenario of A “or” B. Reference to A “or” B may be construed to also encompass the scenario of A “and” B. Any reference to a “threshold” or “sufficiency” may be construed to encompass any applicable value or degree. For example, a threshold level, similarity or degree thereof may be construed to include any values such as 99 percent, 98 percent, 95 percent, 90 percent, 80 percent, 75 percent, or any other value therebetween, or any ranges therebetween. Additionally or alternatively, a threshold similarity or degree may be construed as qualitatively satisfying some condition, such as presence of one or more common features. Any reference to sufficiently similar may also be construed to encompass same or similar meanings as satisfying a threshold.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A system comprising:
one or more processors;
memory storing instructions that, when executed by at least one of the one or more processors, cause the system to perform:
comparing one or more vehicle navigational or environmental attributes of the sensor data frames to one or more defined retainment criteria attributes of a region, wherein the one or more defined retainment criteria attributes are to be satisfied in order to retain a sensor data frame;
generating a retained subset sensor data frames corresponding to the region based on the comparison and based on one or more occupant behavioral attributes corresponding to the sensor data frames; and
automatically programming one or more vehicle functionalities based the retained subset.

2. The system of claim 1, wherein the sensor data frames are captured during operation of a vehicle; and generating the retained subset is further based on contextual information, the contextual information comprising feedback data when the vehicle is in a non-operational status.

3. The system of claim 1, wherein the sensor data frames are captured during operation of a vehicle; and the one or more occupant behavioral attributes comprise one or more indicators of unusual behavior of one or more occupants within the vehicle.

4. The system of claim 3, wherein the sensor data frames are captured during operation of a vehicle; and the one or more indicators of unusual behavior are based on one or more head movements or gaze patterns of the one or more occupants within the vehicle.

5. The system of claim 1, wherein the sensor data frames are captured during operation of a vehicle; and the one or more vehicle navigational attributes are based on a steering angle of a steering wheel and a speed or an acceleration of the vehicle.

6. The system of claim 1, wherein the defined retainment criteria attributes comprise a first set of criteria attributes corresponding to first classifications within a first hierarchical level and a second set of criteria attributes corresponding to second classifications within a second hierarchical level, wherein the second hierarchical level is associated with a higher level of granularity compared to the first hierarchical level.

7. (canceled)

8. The system of claim 6, wherein the first hierarchical level and the second hierarchical level are based on different granularity levels of geographical regions corresponding to capture of the sensor data frames.

9. The system of claim 1, wherein the instructions further cause the system to perform:
transmitting the sensor data frames to a device, wherein:
the defined retainment criteria attributes are generated based on interaction data associated with the sensor data frames on the device.

10. The system of claim 9, wherein the interaction data comprises a frequency of playback of a portion of the sensor data frames on the device.

11. A method comprising:
comparing one or more vehicle navigational or environmental attributes of the sensor data frames to one or more defined retainment criteria attributes of a region, wherein the one or more defined retainment criteria attributes are to be satisfied in order to retain a sensor data frame;
generating a retained subset of sensor data frames corresponding to a region based on the comparison and based on one or more occupant behavioral attributes corresponding to the sensor data frames; and
automatically programming one or more vehicle functionalities based the retained subset.

12. The method of claim 11, wherein the sensor data frames are captured during operation of a vehicle; and generating the retained subset is further based on contextual information, the contextual information comprising feedback data when the vehicle is in a non-operational status.

13. The method of claim 11, wherein the sensor data frames are captured during operation of a vehicle; and the one or more occupant behavioral attributes comprise one or more indicators of unusual behavior of one or more occupants within the vehicle.

14. (canceled)

15. (canceled)

16. (canceled)

17. (canceled)

18. (canceled)

19. (canceled)

20. A non-transitory machine-readable medium having instructions stored therein, which when executed by a processor, cause the processor to perform operations, the operations comprising:
comparing one or more vehicle navigational or environmental attributes of the sensor data frames to one or more defined retainment criteria attributes of a region, wherein the one or more defined retainment criteria attributes are to be satisfied in order to retain a sensor data frame;
generating a retained subset of sensor data frames corresponding to a region based on the comparison and based on one or more occupant behavioral attributes corresponding to the sensor data frames; and
automatically programming one or more vehicle functionalities based the retained subset.

21. The system of claim 1, wherein generating the retained subset comprises:
for each sensor data frame of the sensor data frames:
evaluating the one or more vehicle navigational or environmental attributes against the one or more defined retainment criteria attributes;
in response to the one or more vehicle navigational or environmental attributes satisfying the one or more defined retainment criteria attributes, retaining the frame temporarily as a candidate frame;
in response to the one or more vehicle navigational or environmental attributes failing to satisfy the one or more defined retainment criteria attributes, discarding the frame without retaining the frame; and
in response to the one or more occupant behavioral attributes of the one or more candidate frames matching one or more anomalous behavior attributes, retaining the candidate candidates.

22. The system of claim 1, further comprising one or more datastores, wherein the one or more datastores are configured to store defined retainment criteria according to defined attribute granularity levels corresponding to the defined attributes, wherein:
each hierarchy level of the one or more datastores corresponds to a different defined attribute granularity level, wherein first defined retainment criteria according to a first attribute granularity level is specific to a smaller geographical region and second defined retainment criteria according to a second attribute granularity level is defined across a larger geographical region.

23. The system of claim 1, further comprising one or more datastores, wherein the one or more datastores are configured to store defined retainment criteria according to defined attribute granularity levels corresponding to the defined attributes, wherein:
each hierarchy level of the one or more datastores corresponds to a different defined attribute granularity level, wherein first defined retainment criteria according to a first attribute granularity level is specific to a narrower precondition range and second defined retainment criteria according to a second attribute granularity level is defined across a broader precondition range, wherein precondition ranges correspond to one or more environmental attributes.

24. The system of claim 22, wherein the first defined retainment criteria is based on the defined retainment criteria attributes, the second defined retainment criteria is based on the one or more occupant behavioral attributes, and a third defined retainment criteria defined according to a third granularity level is based on contextual information, the contextual information comprising feedback data when the vehicle is in a non-operational status, the third granularity level being higher than the second granularity level.

25. The system of claim 1, wherein programming one or more vehicle functionalities comprises programming a driver assistance system of the vehicle based on the reformatted subset of the sensor data; and the instructions further cause the system to perform:
executing a navigation action on the vehicle or a different vehicle based on the programmed driver assistance system.

26. The system of claim 1, wherein the instructions further cause the system to perform:
reformatting the retained sensor data frames;
programming a driver assistance system of the vehicle based on the reformatted retained sensor data frames; and
operating the vehicle or a different vehicle based on the programmed driver assistance system.

27. The system of claim 1, wherein generating the retained subset is in accordance with an inferred retainment criteria based on one or more common vehicle navigation or environmental attributes among previously retained sensor data frames, and the instructions further cause the system to perform:
for each qualified sensor data frame of the sensor data frames that satisfies one or more inferred criteria attributes of the inferred criteria, one or more occupant behavior criteria attributes according to the one or more occupant behavioral attributes, and the defined retainment criteria attributes:
evaluating a sensor data frame attribute against one or more previous sensor data frame attributes of the previously retained sensor data frames;
in response to the sensor data frame attribute deviating from the one or more previous sensor data frame attributes by at least a threshold extent, retaining the sensor data frame; and
in response to the sensor data frame attribute deviating from the one or more previous sensor data frame attributes by less than a threshold extent, discarding the sensor data frame without retaining the sensor data frame.
